(19) United States
(12) Patent Application Publication
(10) Pub. No.: US 2025/0075073 A1
(43) Pub. Date: Mar. 6, 2025

(54) COMPOSITION FOR OUTSOLE OF SHOES, OUTSOLE OF SHOES MANUFACTURED USING THE SAME AND MANUFACTURING METHOD THEREOF

(71) Applicant: Elaschem Co., Ltd., Cheonan-si (KR)

(72) Inventors: Je Yong JIN, Busan (KR); Sang Bong Lee, Cheonan-si (KR)

(73) Assignee: ELASCHEM CO., LTD., Cheonan-si (KR)

(21) Appl. No.: 18/823,911

(22) Filed: Sep. 4, 2024

(30) Foreign Application Priority Data
Sep. 6, 2023 (KR) 10-2023-0118174

(51) Int. Cl. C08L 75/04; B29C 48/00; B29C 48/04; B29K 9/00; B29K 75/00; B29K 105/00; C08K 5/29; C08K 5/527

(52) U.S. Cl. CPC C08L 75/04; B29C 48/022; B29C 48/04; C08K 5/29; C08K 5/527; B29K 2009/00; B29K 2075/00; B29K 2105/0088; B29K 2995/007; B29K 2995/0077; B29K 2995/0087

(57) ABSTRACT

Disclosed is a composition for an outsole of shoes that can improve tensile strength, wear resistance, yellowing resistance, transparency, and non-slip characteristics compared to a conventional outsole of shoes, and an outsole of shoes manufactured using the same and a manufacturing method thereof. The composition for the outsole of shoes includes 91 to 97% by weight of a polyurethane-type thermoplastic elastomer and 3 to 9% by weight of a functional composition, wherein the functional composition contains butadiene rubber.

### CROSS-REFERENCE TO RELATED APPLICATION

This application claims the benefit of priority to Korean Patent Application No. 10-2023-0118174 filed on Sep. 6, 2023, the entire contents of which are incorporated herein by reference.

### BACKGROUND

### (a) Technical Field

The present invention relates to a composition for an outsole of shoes, an outsole of shoes manufactured using the same, and a manufacturing method thereof, and more specifically, to a composition for an outsole of shoes, which can improve tensile strength, wear resistance, yellowing resistance, transparency, and non-slip characteristics, compared to conventional outsoles of shoes, and an outsole of shoes manufactured using the same and a manufacturing method thereof.

### (b) Background Art

In general, the sole of shoes is composed of an upper that wraps around the foot, an outsole made of a material with strong wear resistance and grip force as the part that comes into contact with the ground, and an insole located between the upper and the outsole to absorb the shock that occurs when the outsole comes into contact with the ground. Among these, the insole is mainly made of a light and elastic material such as ethylene vinyl acetate (EVA) sponge, and the outsole is manufactured by mixing reinforcing agents such as silica and crosslinking agents such as sulfur into a natural or synthetic rubber, putting them into a mold, and then pressurizing and crosslinking them.

In particular, the outsole requires excellent tensile strength and durability in addition to the wear resistance and grip force (non-slip characteristics) described above. In addition, the use of transparent and white outsoles has been increasing recently, and accordingly, yellowing resistance and transparency, etc. are additionally required. In addition, considering productivity, they are gradually increasing from thermosetting types to thermoplastic types. Although a thermoplastic rubber (TPR) is used as a main component in some outsoles, there are problems in that the mechanical strength and non-slip characteristics are insufficient. Accordingly, thermoplastic polyurethane (TPU) is attracting attention as a material that can replace the thermoplastic rubber as an outsole material, and is currently being developed and used as a material for the outsole of many shoe products.

Korean Patent No. 10-2092733 and Korean Patent No. 10-1756083 also use thermoplastic polyurethane (TPU) as the main material for the outsole of shoes. In addition, these have attempted to improve the problems that have been pointed out in the existing outsole of shoes, such as by using a butadiene-type rubber and other additives (antioxidants, ultraviolet absorbers, crosslinking agents) together to improve the non-slip characteristics and transparency. However, only the non-slip characteristics of the outsole of shoes have been improved, and the main characteristics such as tensile strength, wear resistance, yellowing resistance, and transparency are still at unsatisfactory levels. In addition, the non-slip characteristics also need to be further improved.

Therefore, a method is required to improve the main characteristics of the outsole of shoes, such as tensile strength, wear resistance, yellowing resistance, transparency, and non-slip characteristics.

### PRIOR ART DOCUMENT

### Patent Document

(Patent document 1) Korean Patent No. 10-2092733
(Patent document 2) Korean Patent No. 10-1756083

### SUMMARY OF THE DISCLOSURE

### Technical Problem

Therefore, it is an object of the present invention to provide a composition for an outsole of shoes that can improve tensile strength, wear resistance, yellowing resistance, transparency, and non-slip characteristics, etc., compared to a conventional outsole of shoes, and an outsole of shoes manufactured using the same, and a manufacturing method thereof.

### Technical Solution

In order to achieve the above object, the present invention provides a composition for an outsole of shoes, comprising 91 to 97% by weight of a polyurethane-type thermoplastic elastomer; and 3 to 9% by weight of a functional composition, wherein the functional composition comprises a butadiene rubber.

In addition, the present invention provides an outsole of shoes manufactured using the composition for the outsole of shoes.

In addition, the present invention provides a method for manufacturing an outsole of shoes comprising the steps of a) preparing a mixture by mixing a functional composition including a butadiene rubber and an additive including a crosslinking agent in a kneader at 100 to 120° C. for 10 to 20 minutes: b) preparing a composition for an outsole of shoes by dynamically crosslinking and reactively extruding a polyurethane-type thermoplastic elastomer together with the prepared mixture in an extruder or a closed kneader having a barrel temperature of 120 to 180° C.; and c) forming an outsole of shoes by injection molding or 3D printing the composition for the outsole of shoes prepared above.

### Effects of the Invention

According to the composition for the outsole of shoes according to the present invention, the outsole of shoes manufactured using the same, and the manufacturing method thereof, there is an advantage that the outsole of shoes can improve tensile strength, wear resistance, yellowing resistance, transparency, and non-slip characteristics compared to the conventional outsole of shoes.

### DETAILED DESCRIPTION

Hereinafter, the present invention will be described in detail.

The composition for the outsole of shoes according to the present invention comprises 91 to 97% by weight of a polyurethane-type thermoplastic elastomer; and 3 to 9% by weight of a functional composition, wherein the functional composition comprises a butadiene rubber.

As described above, the sole of a shoe is generally composed of an upper that wraps the foot, an outsole that comes into contact with the ground and must have excellent wear resistance, grip force (non-slip characteristics), tensile strength, yellowing resistance, and transparency, and the insole that is located between the upper and the outsole and absorbs the shock generated when the outsole comes into contact with the ground. Among these, the outsole is manufactured by mixing a natural rubber or synthetic rubber with reinforcing agents such as silica and crosslinking agents such as sulfur, putting them in a mold, and then pressurizing and crosslinking them, and in particular, although a thermoplastic rubber (TPR) is used as a main component, there are problems that the mechanical strength and non-slip characteristics are insufficient. In addition, thermoplastic polyurethane (TPU) is also used as a material for the outsole along with a butadiene-type rubber and other additives (antioxidants, UV absorbers, cross-linking agents), but only the non-slip characteristics (or, slip resistance) of the outsole of shoes are improved, and the main characteristics such as tensile strength, wear resistance, yellowing resistance, and transparency are still at an unsatisfactory level.

Accordingly, the applicant of the present invention, after conducting extensive research, invented a composition for an outsole of shoes that can improve the main characteristics of the outsole of shoes by incorporating thermoplastic polyurethane (TPU) and a functional composition.

First, the polyurethane-type thermoplastic elastomer is an elastomer that not only has excellent wear resistance and mechanical strength, but is also recyclable. In addition, the polyurethane-type thermoplastic elastomer may include at least one of an ester-type polyurethane-type thermoplastic elastomer and an ether-type polyurethane-type thermoplastic elastomer having a hardness of about 85 A (asker A) or less, considering compatibility with the functional composition described below, wear resistance, elasticity, manufacturing cost, etc., and appropriate hardness of the outsole of shoes (which refers to a hardness that can be used as a typical outsole of shoes, and is typically 65 to 75 A (asker A)).

In the art, although the appropriate hardness of a typical outsole of shoes is recognized as described above, a polyurethane-type thermoplastic elastomer having a hardness corresponding thereto has not yet been easily found. However, the applicant of the present invention, after various studies and attempts, has derived a polyurethane-type thermoplastic elastomer having a hardness of 65 to 85 A (asker A), and has made it very easy to approach the hardness value required for the outsole of shoes by applying it to the present invention.

For example, the ester-type polyurethane-type thermoplastic elastomer refers to a polyurethane-type thermoplastic elastomer comprising at least one ester structure (RO—CO—R′, where R and R′ are each an alkyl group), and the ether-type polyurethane-type thermoplastic elastomer refers to a polyurethane-type thermoplastic elastomer comprising at least one ether structure (C—O—C).

The content of the polyurethane-type thermoplastic elastomer is, as described above, 91 to 97% by weight, preferably 92 to 97% by weight, and more preferably 92 to 96% by weight. If the content of the polyurethane-type thermoplastic elastomer is less than 91% by weight, there is a concern that the physical properties such as tensile strength and wear resistance may be deteriorated, and if the content of the polyurethane-type thermoplastic elastomer exceeds 97% by weight, since the content of the remaining components (functional composition, etc.) that make up the composition for the outsole of shoes is relatively reduced, a problem of debris phenomenon may occur.

In addition, it is preferable that the polyurethane-type thermoplastic elastomer have a melting point of 180° C. or lower. The reason is that if the melting point of the polyurethane-type thermoplastic elastomer exceeds 180° C., there is a risk of yellowing as the mixing time becomes longer and the mixing temperature becomes higher.

Next, the functional composition above is intended to further improve the tensile strength and wear resistance of the outsole of shoes, as well as the yellowing resistance, and to impart the transparency. The functional composition basically contains a butadiene rubber. In addition, the functional composition may further contain at least one selected from the group consisting of a styrene butadiene rubber, an ethylene propylene rubber, and ethylene vinyl acetate for the purpose of improving the non-slip characteristics, tensile strength, wear resistance, yellowing resistance, and transparency of the outsole of shoes. In addition, it is preferable that the functional composition of the present invention or the composition for the outsole of shoes does not contain a silicone rubber in order to achieve the purpose of the present invention.

If the functional composition further contains at least one selected from the group consisting of a styrene butadiene rubber, an ethylene propylene rubber, and ethylene vinyl acetate (i.e., the second functional component) in addition to the butadiene rubber (i.e., the first functional component), the first functional component may be contained in an amount of 1 to 7% by weight, preferably 2 to 6% by weight, based on the total weight of the composition for the outsole of shoes, and the second functional component may be contained in an amount of 1 to 5% by weight, preferably 1 to 4% by weight, based on the total weight of the composition for the outsole of shoes.

The content of the functional composition may be 3 to 9% by weight, preferably 3 to 8% by weight, and more preferably 4 to 8% by weight, as described above. If the content of the functional composition is less than 3% by weight, there may be problems that the non-slip characteristics, etc. of the outsole of shoes is deteriorated and the debris phenomenon occurs. In addition, if the content of the functional composition exceeds 9% by weight, there is a concern that as the content of the polyurethane-type thermoplastic elastomer is relatively reduced, the tensile strength and wear resistance in particular are significantly reduced.

However, the composition for the outsole of shoes according to the present invention exhibits the best effect when the functional composition contains only a butadiene rubber in an optimal amount.

In this way, if the functional composition contains only a butadiene rubber, the content of the functional composition may be 3 to 7% by weight, preferably 4 to 6% by weight. In addition, at this time, the content of the polyurethane-type thermoplastic elastomer may be 93 to 97% by weight, preferably 94 to 96% by weight.

Meanwhile, the composition for the outsole of shoes according to the present invention may further contain, if necessary, at least one selected from the group consisting of an acrylonitrile butadiene rubber, a hydrogenated nitrile butadiene rubber, an urethane rubber, an acrylic rubber, an isoprene rubber, a styrene-type block copolymer, a polyolefin elastomer and polyolefin. However, it can be contained in a minimum amount within a range that does not inhibit the effect arising from the organic relationship of the polyurethane-type thermoplastic elastomer and the functional composition. Here, the above styrene-type block copolymer may be, for example, a styrene-ethylene/butylene-styrene block copolymer, and may be used for the purpose of reducing the specific gravity together with a polyolefin elastomer. In addition, at least one selected from the group consisting of a styrene butadiene rubber, an ethylene propylene rubber, and ethylene vinyl acetate may also be further contained in the composition for the outsole of shoes of the present invention as a separate component rather than as a functional composition.

Meanwhile, the composition for the outsole of shoes according to the present invention may further contain, if necessary, at least one additive selected from the group consisting of zinc stearate, calcium stearate, an antioxidant, a crosslinking agent, an ultraviolet absorber, and a light stabilizer. In addition, among these, calcium stearate, a crosslinking agent, an ultraviolet absorber, and a light stabilizer are particularly preferable in terms of controlling the crosslinking speed, improving dispersibility, improving physical properties, improving transparency, and preventing aging of the rubber.

As the antioxidant, examples thereof are those commonly used in the art, but a phosphite-type or phenolic-type antioxidant is particularly preferred. The crosslinking agent may also comprise those commonly used in the art, but a peroxide-type crosslinking agent is particularly preferred. The above ultraviolet absorber may also be exemplified by those commonly used in the art, but a formamidine-type ultraviolet absorber is particularly preferred. The light stabilizer may also be exemplified by those commonly used in the art, but a hindered amine-type light stabilizer (HALS) is particularly preferred. However, in order to achieve the purpose of the present invention, it is preferable that the composition for the outsole of shoes of the present invention not contain a processing oil (e.g., paraffin oil, white oil, naphthenic oil, aromatic oil, etc.) in terms of tensile strength and adhesive characteristics. The above peroxide-type crosslinking agent has a purity of 99% or higher. If the purity of the peroxide-type crosslinking agent is less than 99%, there is a risk that transparency may be reduced. The peroxide-type crosslinking agent may be exemplified by cyclohexanone peroxide, t-butylperoxyisopropyl carbonate, t-butylperoxylaurylate, t-butylperoxyacetate, di-t-butyldiperoxyphthalate, t-dibutylperoxymaleic acid, t-butylcumyl peroxide, t-butyl hydroperoxide, t-butylperoxy benzoate, dibenzoyl peroxide, dicumyl peroxide, 1,3-bis(t-butylperoxyisopropyl)benzene, methylethylcapone peroxide, di-(2,4-dichlorobenzoyl)peroxide, 1,1-di(t-butylperoxy)-3,3,5-trimethylcyclohexane, 2,5-dimethyl-2,5-(t-benzoylperoxy)hexane, 2,5-dimethyl-2,5-di(t-butylperoxy)hexane, di-t-butylperoxide, 2,5-dimethyl-2,5-(t-butylperoxy)-3-hexyne, n-butyl-4,4-bis(t-butylperoxy) valerate, a,a′-bis(t-butylperoxy)diisopropylbenzene and two or more of these.

If the composition for the outsole of shoes of the present invention contains at least one additive of zinc stearate, calcium stearate, an antioxidant, a crosslinking agent, an ultraviolet absorber, and a light stabilizer, the zinc stearate may be contained in an amount of 2 to 15 parts by weight based on 100 parts by weight of the total weight of the functional composition. The calcium stearate may also be contained in an amount of 2 to 15 parts by weight based on 100 parts by weight of the total weight of the functional composition. The antioxidant may also be contained in an amount of 2 to 15 parts by weight based on 100 parts by weight of the total weight of the functional composition. The crosslinking agent may be contained in an amount of 0.05 to 2 parts by weight based on 100 parts by weight of the total weight of the functional composition. The ultraviolet absorber may be contained in an amount of 3 to 15 parts by weight based on 100 parts by weight of the total weight of the functional composition. The photostabilizer may also be contained in an amount of 3 to 15 parts by weight based on 100 parts by weight of the total weight of the functional composition.

The present invention provides an outsole of shoes manufactured using the composition for the outsole of shoes described above. The outsole of shoes according to the present invention is characterized in that the tensile strength is 200 to 220 kgf/cm². In addition, the outsole of shoes according to the present invention has an Akron abrasion loss (cc loss) satisfying the following Equation 1.

$$[ Equation l ]$$

$$Akron abrasion loss ( cc loss ) = 0.06 < \text{} \frac{\begin{matrix}weight reduced after the specimen \\ of the outsole of the shoe was worn\end{matrix}}{\begin{matrix}specific gravity of the specimen \\ of the outsole of the shoe\end{matrix}} \times 100 < 0.11$$

In addition, a method for manufacturing an outsole of shoes using the composition for the outsole of shoes is described below.

The method for manufacturing the outsole of shoes according to the present invention comprises the steps of a) preparing a mixture by mixing a functional composition including a butadiene rubber and an additive including a crosslinking agent in a kneader at 100 to 120° C. for 10 to 20 minutes, b) preparing a composition for an outsole of shoes by dynamically crosslinking and reactively extruding a polyurethane-type thermoplastic elastomer together with the prepared mixture in an extruder or a closed kneader having a barrel temperature of 120 to 180° C. and c) forming an outsole of shoes by injection molding or 3D printing the composition for the outsole of shoes prepared above.

The description of the functional composition, additives and polyurethane-type thermoplastic elastomer is identical to that described above in the composition for the outsole of shoes.

The extruder in step b) above may be a single-screw extruder or a twin-screw extruder.

The composition for the outsole of shoes manufactured in step b) or used in step c) may be in the form of, for example, pellets, but is not limited thereto.

In addition, if injection molding is used in step c), for example, the outsole of shoes can be manufactured by molding the above composition for the outsole of shoes using a mold at a barrel temperature of 160 to 200° C. However, a 3D printing method that is more environmentally friendly and easier to work with than the injection molding method may be preferable.

In addition, since steps a) and b) above are included in the already widely known manufacturing process of the outsole of shoes, a detailed description thereof will be omitted.

Hereinafter, the present invention will be described in more detail through specific examples. The following examples are intended to illustrate the present invention, and the present invention is not limited to the following examples.

### [Examples 1 to 7] Manufacturing of Specimen of Outsole of Shoe

According to composition in Table 1 or 2 below, the functional composition and the additives were mixed in a 110 L internal kneader (manufacturer: Taekwang ENG) at 100 to 120° C. for 10 to 20 minutes to prepare a mixed material, and then, together with this, a polyurethane-type thermoplastic elastomer (TPU) was dynamically crosslinked and reactively extruded in an extruder having a barrel temperature of 120 to 180° C. to prepare a composition for the outsole of shoes in the form of pellets. Next, the composition for the outsole of shoes manufactured as described above was injection molded to manufacture specimens of the outsole of shoes according to Examples 1 to 7. In Tables 1 and 2 below, Examples 1 to 6 used only the butadiene rubber as a butadiene-type rubber, and Example 7 used 2% by weight of the butadiene rubber and 1% by weight of the styrene butadiene rubber as a butadiene-type rubber.

TABLE 1

| | | Example | Example | Example | Example | Example |
|---|---|---|---|---|---|---|
| | | 1 | 2 | 3 | 4 | 5 |
| polyurethane-type thermoplastic elastomer (TPU) | | 97 | 96 | 95 | 94 | 93 |
| Functional composition | butadiene-type rubber | 3 | 4 | 5 | 6 | 7 |
| | ethylene propylene rubber | — | — | — | — | — |
| | ethylene vinyl acetate | — | — | — | — | — |
| Additive | zinc stearate | 5 | 5 | 5 | 5 | 5 |
| | calcium stearate | 5 | 5 | 5 | 5 | 5 |
| | antioxidant | 5 | 5 | 5 | 5 | 5 |
| | crosslinking agent | 2 | 2 | 2 | 2 | 2 |
| | UV absorber | 10 | 10 | 10 | 10 | 10 |
| | light stabilizer | 10 | 10 | 10 | 10 | 10 |

* Content unit of the polyurethane-type thermoplastic elastomer and the functional composition: wt %
* Content of the additive (parts by weight): based on 100 parts by weight of the total weight of the functional composition
* Antioxidant: bis(2,4-di-tert-butylphenyl)pentaerythritol diphosphite
* Crosslinking agent: bis(t-butylperoxy isopropyl)benzene
* UV absorber: N-(4-Ethoxycarbonylphenyl)-N′-Methyl-N′ Phenylformamidine
* Light stabilizer: Poly(4-hydroxy-2,2,6,6-tetramethyl-1-piperidineethanol-alt-1,4-butanedioic acid)

TABLE 2

| | | Example 6 | Example 7 |
|---|---|---|---|
| polyurethane-type thermoplastic elastomer (TPU) | | 92 | 96 |
| Functional | butadiene-type rubber | 5 | 3 |
| composition | ethylene propylene rubber | — | 1 |
| | ethylene vinyl acetate | 3 | — |
| Additive | zinc stearate | 10 | 5 |
| | calcium stearate | 10 | 5 |
| | antioxidant | 5 | 5 |
| | crosslinking agent | 1 | 2 |
| | UV absorber | 10 | 10 |
| | light stabilizer | 10 | 10 |

* Content unit of the polyurethane-type thermoplastic elastomer and the functional composition: wt %
* Content of the additive (parts by weight): based on 100 parts by weight of the total weight of the functional composition
* Antioxidant: bis(2,4-di-tert-butylphenyl)pentaerythritol diphosphite
* Crosslinking agent: bis(t-butylperoxy isopropyl)benzene
*UV absorber: N-(4-Ethoxycarbonylphenyl)-N′-Methyl-N′ Phenylformamidine
* Light stabilizer: poly(4-hydroxy-2,2,6,6-tetramethyl-1-piperidineethanol-alt-1,4-butanedioic acid)

### [Comparative Examples 1 to 3] Manufacturing of Specimen of Outsole of Shoe

According to composition in Table 3 below, the rubber composition and the additives were mixed in a 110 L internal kneader (manufacturer: Taekwang ENG) at 100 to 120° C. for 10 to 20 minutes to prepare a mixed material, and then, together with this, a polyurethane-type thermoplastic elastomer (TPU) was crosslinked and reactively extruded in an extruder set to a barrel temperature of 120 to 180° C. to prepare a composition for the outsole of shoes in the form of a pellet. Then, the prepared composition for the outsole of shoes was injection molded to prepare specimens of the outsole of shoes according to Comparative Examples 1 to 3.

TABLE 3

| | | Comparative | Comparative | Comparative |
|---|---|---|---|---|
| | | Example 1 | Example 2 | Example 3 |
| polyurethane-type thermoplastic elastomer (TPU) | | 60 | 90 | 80 |
| Rubber | TPU | 8 | 5 | — |
| composition | polybutadiene | 32 | — | — |
| | polystyrene-butadiene rubber | — | 5 | — |
| | silicone rubber | — | — | 7.5 |
| | butadiene rubber | — | — | 12.5 |
| Additive | liquid isoprene rubber | — | — | 7.5 |
| | zinc stearate | 0.2 | 1.0 | 0.3 |
| | calcium stearate | 0.2 | 1.0 | 0.5 |
| | antioxidant | 0.5 | 5 | 0.1 |
| | processing oil (paraffin oil) | 5 | 10 | — |
| | crosslinking agent | 0.1 | 5 | 0.05 |
| | UV absorber | — | — | 0.7 |

* Content unit of the polyurethane-type thermoplastic elastomer and the rubber composition: wt %
* Content of the additive of Comparative Examples 1 and 2 (parts by weight): based on 100 parts by weight of the total weight of the rubber composition
* Content of the additive of Comparative Example 3 (parts by weight): based on 100 parts by weight of the total weight of TPU and the rubber composition
* Antioxidant: bis(2,4-di-tert-butylphenyl)pentaerythritol diphosphite
* Crosslinking agent: cyclohexanone peroxide
* UV absorber: N-(4-Ethoxycarbonylphenyl)-N′-Methyl-N′ Phenylformamidine

### [Comparative Examples 4 and 5] Manufacturing of Specimen of Outsole of Shoe

Specimens of the outsole of shoes according to Comparative Examples 4 and 5 were manufactured in the same manner as in Examples 1 to 7 above, except that the compositions were as shown in Table 4 below. In Table 4 below, Comparative Examples 4 and 5 used only the butadiene rubber as a butadiene-type rubber.

TABLE 4

| | | Comparative | Comparative |
|---|---|---|---|
| | | Example 4 | Example 5 |
| polyurethane-type | | 98 | 92 |
| thermoplastic elastomer (TPU) | | | |
| Functional | butadiene-type rubber | 2 | 8 |
| composition | ethylene propylene rubber | — | |
| | ethylene vinyl acetate | — | |
| Additive | zinc stearate | 5 | 5 |
| | calcium stearate | 5 | 5 |
| | antioxidant | 5 | 5 |
| | crosslinking agent | 2 | 2 |
| | UV absorber | 10 | 10 |
| | light stabilizer | 10 | 10 |

* Content unit of the polyurethane-type thermoplastic elastomer and the functional composition: wt %
* Content of the additive (parts by weight): based on 100 parts by weight of the total weight of the functional composition
* Antioxidant: bis(2,4-di-tert-butylphenyl)pentaerythritol diphosphite
* Crosslinking agent: bis(t-butylperoxy isopropyl)benzene
* UV absorber: N-(4-Ethoxycarbonylphenyl)-N′-Methyl-N′ Phenylformamidine
* Light stabilizer: poly(4-hydroxy-2,2,6,6-tetramethyl-1-piperidineethanol-alt-1,4-butanedioic acid)

### [Experimental Example] Evaluation of Physical Properties of Outsole of Shoe

The specimens of the outsole of shoes manufactured in Examples 1 to 7 and Comparative Examples 1 to 5 were evaluated using the items and methods below, and the results are shown in Tables 5 and 6 below.

1) Hardness (Shore A): an asker A type hardness tester was used and the hardness was measured according to the ASTM D-2240 standard test method.

2) Tensile strength (kgf/cm²) and elongation rate (%): after making test specimens using a die A cutter, the tensile strength and elongation rate were measured according to the ASTM D-412 standard test method. At this time, five test specimens were used for the same test.

3) Tear strength (kgf/cm): it was measured according to the ASTM D-634 standard test method, and after repeating the test five times, specimens that deviated more than 20% from the median were excluded and the average was measured.

4) Wear resistance (akron): it was measured according to KSM 6624, and the Akron abrasion loss (cc loss) was calculated by Equation 1 below.

$$[ Equation l ]$$

$$Akron abrasion loss ( cc loss ) = 0.06 < \text{} \frac{\begin{matrix}weight reduced after the specimen \\ of the outsole of the shoe was worn\end{matrix}}{\begin{matrix}specific gravity of the specimen \\ of the outsole of the shoe\end{matrix}} \times 100 < 0.11$$

5) QUV (UV-promoted weather resistance, Gray scale): it was evaluated according to AATCC 186.

6) Yellowing phenomenon resistance: it was evaluated by visual inspection over time.

7) Transparency: total light transmittance and haze were evaluated using a spectrophotometer and a haze meter according to ASTM 1003.

8) Slip resistance (wet): slip resistance was evaluated by measuring the dynamic friction coefficient when the specimen was moved at a constant speed on a glass plate sprayed with water (wet) according to ASTM D1894.

TABLE 5

| | Example | Example | Example | Example | Example | Example | Example |
|---|---|---|---|---|---|---|---|
| | 1 | 2 | 3 | 4 | 5 | 6 | 7 |
| Hardness (Shore | 68 | 67 | 67 | 66 | 66 | 66 | 67 |
| A) | | | | | | | |
| Tensile strength | 218 | 212 | 208 | 204 | 201 | 205 | 212 |
| (kgf/cm²) | | | | | | | |
| Elongation rate | 840 | 880 | 875 | 862 | 845 | 842 | 884 |
| (%) | | | | | | | |
| Tear strength | 69 | 69 | 69 | 68 | 67 | 68 | 69 |
| (kgf/cm) | | | | | | | |
| Wear resistance | 0.0688 | 0.0658 | 0.0644 | 0.0915 | 0.1054 | 0.1026 | 0.0673 |
| (akron) | | | | | | | |
| QUV | 4.5 | 4.5 | 4.5 | 4 | 4 | 4 | 4.5 |
| Yellowing | After 8 | After 8 | After 8 | After 8 | After 8 | After 8 | After 8 |
| phenomenon | weeks, | weeks, | weeks, | weeks, | weeks, | weeks, | weeks, |
| resistance (visual | yellowing | yellowing | yellowing | yellowing | yellowing | yellowing | yellowing |
| inspection) | phenomenon | phenomenon | phenomenon | phenomenon | phenomenon | phenomenon | phenomenon |
| | occurs | occurs | occurs | occurs | occurs | occurs | occurs |
| Transparency | 92 | 91.7 | 91 | 90.4 | 90 | 89.8 | 91.5 |
| (total light | | | | | | | |
| transmittance, %) | | | | | | | |
| Transparency | 0.4 | 0.4 | 0.5 | 0.6 | 0.6 | 0.6 | 0.5 |
| (haze, %) | | | | | | | |
| Slip resistance | 1.20 | 1.27 | 1.29 | 1.30 | 1.31 | 1.29 | 1.25 |
| (wet) | | | | | | | |

TABLE 6

| | Comparative | Comparative | Comparative | Comparative | Comparative |
|---|---|---|---|---|---|
| | Example | Example | Example | Example | Example |
| | 1 | 2 | 3 | 4 | 5 |
| Hardness (Shore A) | 65 | 65 | 60 | 70 | 64 |
| Tensile strength | 126 | 122 | 183 | 225 | 172 |
| (kgf/cm²) | | | | | |
| Elongation rate (%) | 613 | 632 | 849 | 740 | 817 |
| Tear strength (kgf/cm) | 66 | 66 | 57 | 69 | 65 |
| Wear resistance | 0.1847 | 0.1398 | 0.2373 | 0.0641 | 0.1566 |
| (Akron) | | | | | |
| QUV | 3.5 | 3 | 3.5 | 4.5 | 4 |
| Yellowing | After 2 | After 2 | After 2 | After 8 | After 6 |
| phenomenon | weeks, | weeks, | weeks, | weeks, | weeks, |
| resistance (visual | yellowing | yellowing | yellowing | yellowing | yellowing |
| inspection) | phenome- | phenome- | phenome- | phenome- | phenome- |
| | non occurs | non occurs | non occurs | non occurs | non occurs |
| Transparency (total | 89.2 | 88.3 | 82 | 92.5 | 90 |
| light transmittance, %) | | | | | |
| Transparency | 0.7 | 0.9 | 0.9 | 0.4 | 0.7 |
| (haze, %) | | | | | |
| Slip resistance (wet) | 1.13 | 1.12 | 0.9 | 1.05 | 1.35 |

As a result of measuring the physical properties of each of the specimens of the outsole of shoes manufactured in Examples 1 to 7 and Comparative Examples 1 to 5, the specimens of the outsole of shoes of Examples 1 to 7 showed excellent characteristics (elongation rate, slip resistance, and flexibility), which are particularly important in the shoe industry, as the content of the butadiene-type rubber is increased, compared to the specimens of the outsole of shoes of Comparative Examples 1 to 5 (In particular, both elongation and slip resistance must be excellent characteristics at the same time).

In addition, it was confirmed that the applicant of the present invention attempted to maintain the non-slip characteristics at a level similar to that of the existing ones by using a polyurethane-type thermoplastic elastomer known to have a particular advantage in non-slip characteristics (or, slip resistance), but as a result of carrying out the experiment within the composition and content range of the present invention, the non-slip characteristics were also improved compared to the existing ones.

Therefore, it can be seen that if a composition for the outsole of shoes is manufactured through a specific mixing method, such as using the butadiene rubber in a small amount compared to the existing one and not using the silicone rubber, the characteristics of the outsole of shoes are improved compared to the existing one.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A composition for the outsole of shoes comprising 91 to 97% by weight of a polyurethane-type thermoplastic elastomer; and 3 to 9% by weight of a functional composition,
wherein the functional composition comprises a butadiene rubber.

2. The composition for the outsole of shoes according to claim 1, wherein the composition for the outsole of shoes does not contain a silicone rubber and a processing oil.

3. The composition for the outsole of shoes according to claim 1, wherein the functional composition further contains at least one selected from the group consisting of a styrene butadiene rubber, an ethylene propylene rubber and ethylene vinyl acetate.

4. the composition for the outsole of shoes according to claim 1, wherein the polyurethane-type thermoplastic elastomer has a hardness of 65 to 85 A (asker A).

5. The composition for the outsole of shoes according to claim 1, wherein the composition for the outsole of shoes further contains at least one selected from the group consisting of an acrylonitrile butadiene rubber, a hydrogenated nitrile butadiene rubber, a urethane rubber, an acrylic rubber, an isoprene rubber, a styrene-type block copolymer, a polyolefin elastomer and polyolefin.

6. The composition for the outsole of shoes according to claim 1, wherein the composition for the outsole of shoes further contains one or more additives among zinc stearate, calcium stearate, antioxidant, crosslinking agent, UV absorber and light stabilizer.

7. An outsole of shoes manufactured using the composition for the outsole of shoes according to any one of claims 1 to 6.

8. The outsole of shoes according to claim 7, wherein the tensile strength of the outsole of shoes is 200 to 220 kgf/cm².

9. The outsole of shoes according to claim 8, wherein the Akron abrasion loss (cc loss) of the outsole of shoes satisfies Equation 1 below:
$$[ Equation l ]$$
$$Akron abrasion loss ( cc loss ) = 0.06 < \text{} \frac{\begin{matrix}weight reduced after the specimen \\ of the outsole of the shoe was worn\end{matrix}}{\begin{matrix}specific gravity of the specimen \\ of the outsole of the shoe\end{matrix}} \times 100 < 0.11 .$$

10. A method for manufacturing the outsole of shoes comprising the steps of,
a) preparing a mixture by mixing a functional composition including butadiene rubber and an additive including a crosslinking agent in a kneader at 100 to 120° C. for 10 to 20 minutes;
b) preparing a composition for an outsole of shoes by dynamically crosslinking and reactively extruding a polyurethane-type thermoplastic elastomer together with the prepared mixture in an extruder or a closed kneader having a barrel temperature of 120 to 180° C.; and
c) forming an outsole of shoes by injection molding or 3D printing the composition for the outsole of shoes prepared above.
